(19) United States
(12) Patent Application Publication
(10) Pub. No.: US 2018/0274519 A1
(43) Pub. Date: Sep. 27, 2018

(54) TOOTHING FOR A ROTARY JOINT AND ROTARY JOINT OF A WIND TURBINE

(71) Applicant: Nordex Energy GmbH, Hamburg (DE)

(72) Inventors: Christine MANTEUFFEL, Luebsdorf (DE); Ibrahim MUHAMAD, Rostock (DE)

(73) Assignee: Nordex Energy GmbH, Hamburg (DE)

(21) Appl. No.: 15/927,563

(22) Filed: Mar. 21, 2018

(30) Foreign Application Priority Data
Mar. 21, 2017 (EP) 17 162 070.1

(51) Int. Cl. F03D 7/02; F16H 1/22

(52) U.S. Cl. CPC F03D 7/0224; F05B 2260/79; F16H 1/227; F03D 7/0204

(57) ABSTRACT

A rotary joint of a wind turbine and toothing for a rotary joint is provided to reduce the production cost for a rotary joint and to enable a stiffening of the rotary joint. An inner ring or outer ring of a rotary joint (bearing) is not completely bored before the milling of the teeth. The material above the teeth is completely retained as a circumferential residual material ring in the blank of the inner ring or the outer ring. The individual teeth are milled by the milling tool only until the required tooth height is reached. The residual material above the teeth is completely retained circumferentially. It reinforces and stiffens the inner ring or the outer ring of the rotary joint. The individual teeth are stabilized at the end face by the residual material above the teeth at the transition to the solid material.

This nonprovisional application claims priority under 35 U.S.C. § 119(a) to European Patent Application No. 17 162 070.1, which was filed on Mar. 21, 2017, and which is herein incorporated by reference.

### BACKGROUND OF THE INVENTION

### Field of the Invention

The invention relates to a toothing for a rotary joint and to a rotary joint of a wind turbine.

### Description of the Background Art

A wind turbine usually has a tower and a nacelle mounted on the tower head and rotatable about the longitudinal axis of the tower. The nacelle carries the rotor with a rotor hub and at least one rotor blade, as well as a generator that converts the energy extracted from the wind by the rotor into electrical energy. In wind turbines different adjusting devices are used to rotate different components. For example, a pitch system is needed for the angle adjustment (pitch angle) of the rotor blades of the turbine or a yaw system for rotating the nacelle of the wind turbine with the wind. To adjust the blade angle (pitch angle), the rotor blades are rotated about their longitudinal axis. The rotor blade adjusting device (pitch system) is usually part of a so-called blade pitch angle control (pitch control).

The yaw system is typically located between the tower head and the nacelle, and in a typical implementation comprises multiple yaw drives, a yaw bearing, and optionally, multiple yaw brake calipers. The components of the yaw system can be located both in the nacelle and in the tower. The yaw bearing usually has an inner ring and an outer ring, wherein both the inner ring and the outer ring have a toothing or can be connected to a gear ring. Either the inner ring is connected to the nacelle and the outer ring is coupled to the tower or the inner ring is coupled to the tower and the outer ring is connected to the nacelle. The yaw drives usually have an adjusting drive, for example, an electric motor, a gearbox, typically a planetary gear, a pinion, and optionally a braking device, for example, an electric brake.

Usually, a pitch bearing of a rotor blade adjusting device has an outer ring and an inner ring, which are mounted rotatable relative to one another. The inner ring is generally provided with toothing in which the pinion of the adjusting drive engages. The individual teeth of the toothing of the inner ring are only tangentially connected to the inner ring. They are machined out of the solid material of the inner ring and project out individually.

As a rule, the adjusting devices have one or more adjusting drives, a planetary gear, a motor, for example, an electric motor, a pinion, and optionally a braking device, for example, an electric brake. The torques and speeds are geared up or down via the toothing in the gearboxes.

The adjusting devices are exposed to dynamic alternating loads, in particular due to changing wind conditions, with increased wear of the stressed parts being the result. The toothing of the gearboxes in particular is disproportionately highly stressed. This can lead to changes in the tooth clearance of the individual meshing engagements, which changes the elasticity of the gearboxes.

US 20140377069 A1 discloses a pitch bearing assembly with a reinforcing element in order to improve the stiffness of the bearing cup of the pitch bearing. For this purpose, a stiffening ring is mounted above the inner ring. Similar solutions are disclosed in US 20150003986 A1, US 20150056078 A, EP 2933476 A1, WO 2013107452 A1, and WO 2013076754 A1.

WO 2013/071936 A1 describes a rotary joint for a wind turbine with a bearing with an inner ring and an outer ring. The inner ring or the outer ring is operatively connected to an adjusting drive. A spacer ring segment is disposed between a first bearing ring and a first ring gear segment. The spacer ring segment has a toothed surface on both sides, so that two toothed interfaces are provided in the connection between the first bearing ring and the first ring gear segment. The spacer ring segment reduces the inner diameter of the bearing ring.

A rotary joint for a wind turbine with a bearing with an inner ring and an outer ring is disclosed in WO 2013/076754 A1. A circular plate adjoins as a separate part the radial inner wall of the inner bearing ring and is fixed there.

DE 4308914 A1 describes a planetary reduction gear having a cylindrical substantially dish-shaped internally toothed wheel which is closed at one end and open at the other. The internally toothed wheel is made of sheet metal by a rotary roll process on a gear-shaped mandrel mold.

### SUMMARY OF THE INVENTION

It is therefore an object of the invention is to reduce the production cost for a rotary joint and to enable a stiffening of the rotary joint.

In an exemplary embodiment, a toothing for a rotary joint is introduced into a solid material by machining. The toothing is characterized in that an interdental space is made between two adjacent teeth, each space having an arcuate termination, in such a way that a defined tooth height h is ensured. A circumferential residual material ring is disposed above the arcuate termination.

In an embodiment of the toothing, the individual teeth along the defined tooth height can have a typical tooth geometry for an involute toothing.

In an embodiment of the toothing, the interdental space between the individual teeth can have a defined width.

In an embodiment of the toothing, the arcuate termination of the interdental space can be ogival or round-arched. An exemplary shape of the arcuate termination of the interdental space is ogival.

Likewise, the object is attained by a rotary joint of a wind turbine in that the inner ring or outer ring of a rotary joint (bearing) is not completely bored before the milling of the teeth. The material above the teeth is completely retained as a circumferential residual material ring in the blank of the inner ring or the outer ring. The individual teeth are milled by the milling tool only until the required tooth height is reached. The residual material above the teeth is completely retained circumferentially. It reinforces and stiffens the inner ring or the outer ring of the rotary joint. According to an embodiment of the invention, the individual teeth are held thereby not only in the tooth root on the inner ring or on the outer ring. They are also stabilized at the end face by the residual material above the teeth at the transition to the solid material of the inner ring or the outer ring.

The teeth of the toothing according to the invention have a defined tooth height, which are introduced starting from a lower end face of the inner ring or the outer ring. The toothing has a number of interdental spaces between the teeth, with an arcuate termination in the direction of an upper end face of the inner ring or the outer ring. The circumferential residual material ring thus remains between the upper end face and the arcuate termination on the inner ring or on the outer ring.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic illustration of a wind turbine;

FIG. 2 is a perspective illustration of the prior art;

FIG. 3 is a perspective partial illustration of an outer ring and an inner ring of an exemplary embodiment of a pitch bearing;

FIG. 4 is a perspective partial illustration of the outer ring and the inner ring with a cutout of the exemplary embodiment of a pitch bearing;

FIG. 5 is a section through the outer ring and the inner ring of the exemplary embodiment of a pitch bearing; and

FIG. 6 is a schematic illustration of the inner ring with a view of the toothing in a cutout of the exemplary embodiment of a pitch bearing; and

FIG. 7 is an illustration of a yaw system.

### DETAILED DESCRIPTION

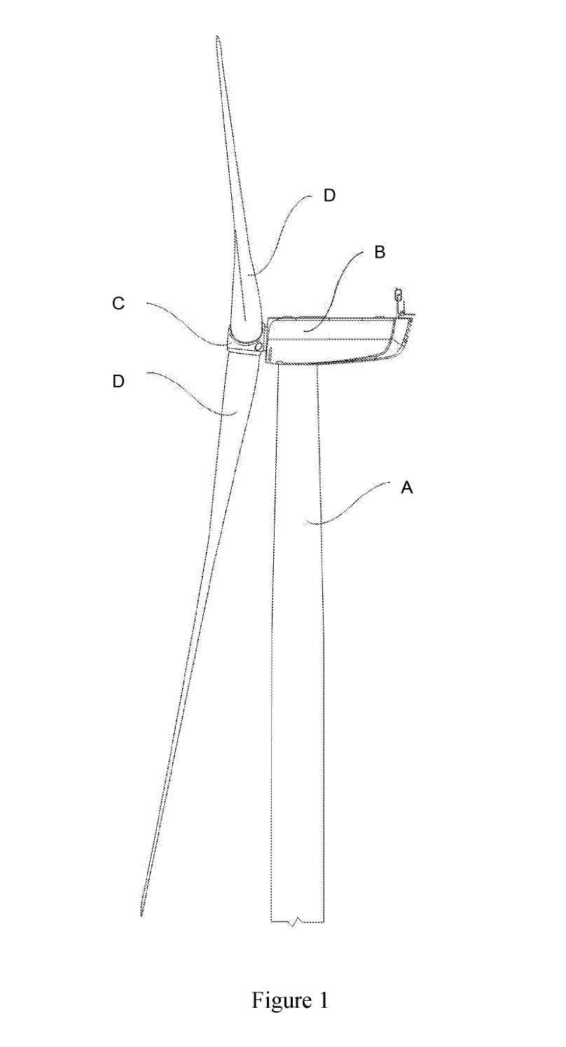

FIG. 1 is a schematic illustration of a wind turbine, which has a tower A and a nacelle B, which is rotatably mounted on the tower head and for its part supports a drive train. The drive train has a rotor hub C, which is connected to, for example, three rotor blades D. In wind turbines, different adjusting devices are used to rotate these different components. These adjusting devices generally have rotary joints (bearings) with an inner ring and an outer ring.

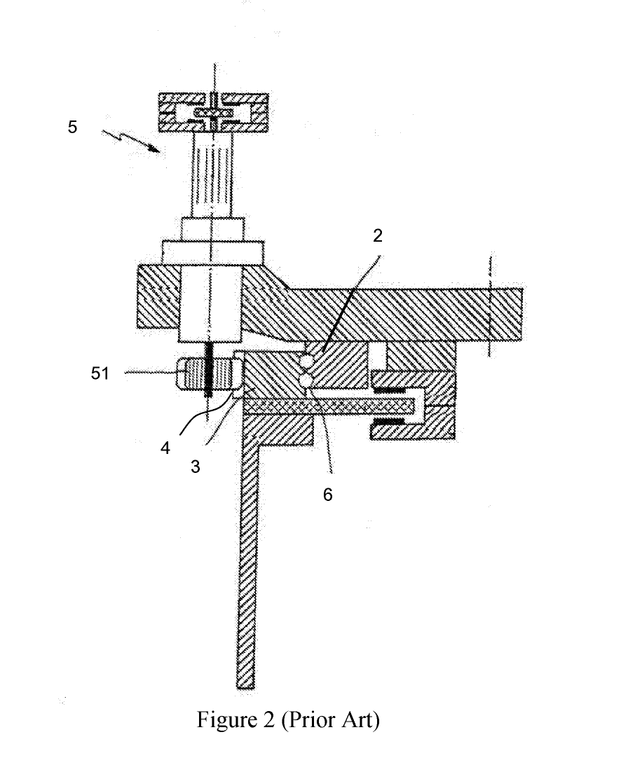

FIG. 2 shows a perspective illustration of the prior art for a pitch bearing 1. Pitch bearing 1 has an outer ring 2 and an inner ring 3. Outer ring 2 and inner ring 3 are movably supported against each other. Inner ring 3 is fixedly connected to rotor blade D. Outer ring 2 is fixedly connected to a rotor hub C. Inner ring 3 is provided with a toothing 4 in which pinion 51 of adjusting drive 5 engages. The individual teeth of toothing 4 of inner ring 3 are completely machined out of the material of inner ring 3.

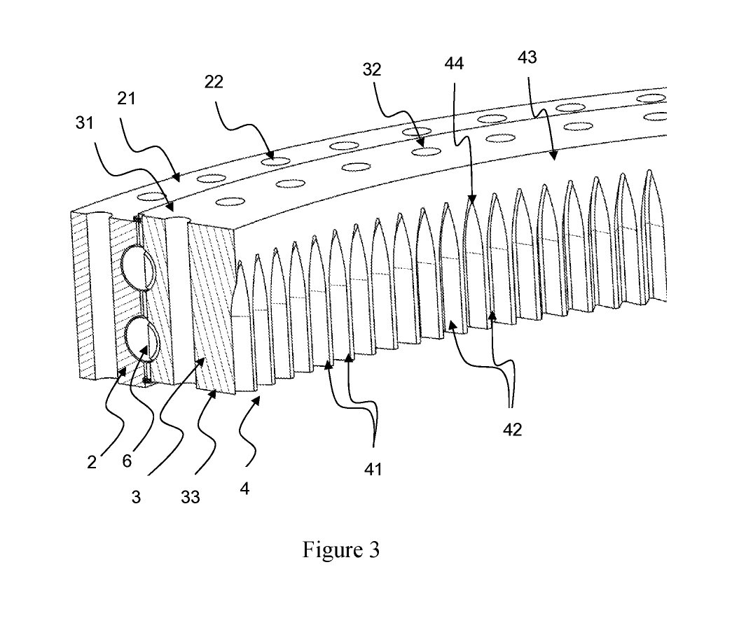

FIGS. 3 and 4 show a perspective partial illustration of a pitch bearing 1 of the invention with an outer ring 2 and an inner ring 3. In FIG. 4, inner ring 3 is provided with a cutout Z for better illustration. Inner ring 3 has a total height H. Bores 32 are introduced on the upper end face 31. The connection with the rotor blade is made by these bores 32. Bores 22 on the upper end face 21 of outer ring 2 are used for attachment to the rotor hub. Inner ring 3 is provided with a toothing 4, which is introduced starting from the lower end face 33 of inner ring 3 in the inner side of inner ring 3. Toothing 4 is, for example, an involute toothing and has a defined tooth height h for optimum engagement of pinion 51 of adjusting drive 5 in toothing 4. The geometry of the individual teeth 41 over the entire tooth height h corresponds to the usual tooth geometry for the respective application. The individual teeth 41 are bored, for example, by milling. Interdental space 42 between teeth 41 has a defined width b for the defined tooth height h of toothing 4. The width b of interdental space 42 decreases above the defined tooth height h, so that interdental space 42 is arcuate, in particular ogival, in the direction of upper end face 31 of inner ring 3 and forms a punctiform or round-arched termination 44 on the inner side of inner ring 3. By this constructive arrangement of interdental spaces 42, teeth 41 widen above tooth height h and merge into a residual material ring 43, which extends up to the upper end face 31 of inner ring 3. Inner ring 3 is very stable due to arcuate interdental space 42 and the remaining residual material ring 43.

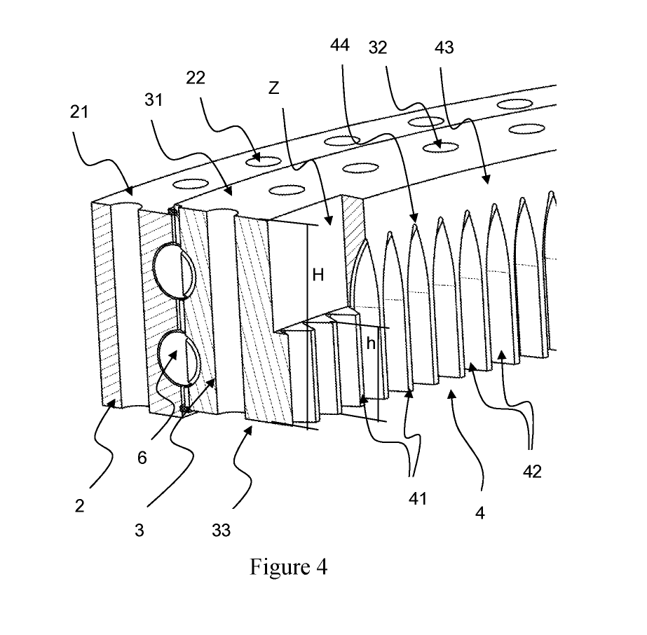

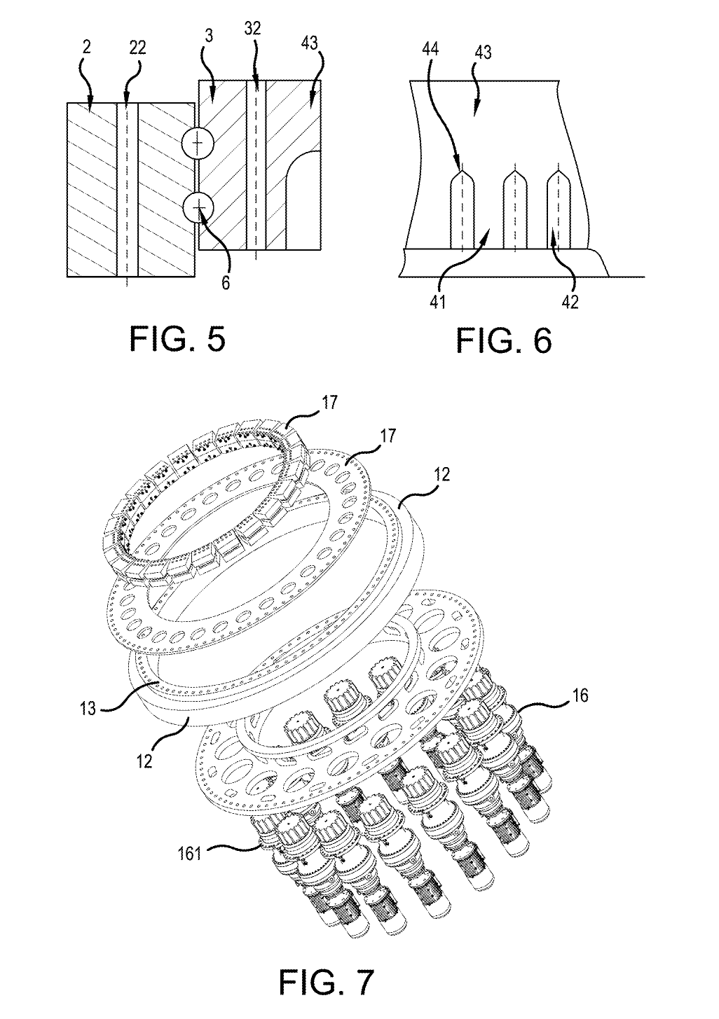

FIGS. 5 and 6 show a further embodiment of toothing 4 of the invention.

A section through outer ring 2 and inner ring 3 is shown in FIG. 5. Outer ring 2 with a bore 22 and inner ring 3 with a bore 32, bearing 6 between outer ring 2 and inner ring 3, and an example of the geometry of toothing 4 in inner ring 3 can be seen. It is possible that interdental spaces 42 also end with a different angle than the one shown here. It is essential to the invention that interdental spaces 42 end in an arcuate shape, because this achieves a greater stability.

FIG. 6 shows a schematic illustration of inner ring 3 of a pitch bearing with a view of toothing 4 in a cutout.

A further exemplary embodiment will be explained with reference to a yaw system for rotating nacelle B. To this end, FIG. 7 shows an illustration of a yaw rotary joint 11 with an outer ring 12 and an inner ring 13. Furthermore, one or more yaw drives 16 and optionally a yaw braking device 17 are mounted. Yaw drives 16, as shown here, can be installed suspended in tower A, so that yaw rotary joint 11 is disposed below nacelle B in tower A. Yaw drives 16 work together with a toothing 14. In this example, yaw drives 16 engage with a pinion 161 in internal toothing 14a of inner ring 13. This internal toothing 14a is constructed in accordance with toothing 4 of the invention of pitch bearing 1 and therefore does not need to be explained in greater detail.

A further important embodiment is that yaw drives 16 protrude upright into nacelle B. Outer ring 12 of yaw rotary joint 11 in this case is fixedly connected to nacelle B and inner ring 13 of yaw rotary joint 11 is fixedly connected to tower A. It is possible in this case that yaw drives 16 engage both in internal toothing 14a of inner ring 13 and in an outer toothing 14b of outer ring 12. In an arrangement of yaw drives 16 with an engagement in outer toothing 14b of outer ring 12, said outer toothing 14b is also constructed in accordance with toothing 4 of the invention of pitch bearing 1 and therefore does not need to be explained in greater detail.

Because the rotary joints of a wind turbine described in detail above are exemplary embodiments, they can be modified to a large extent in a customary manner by the skilled artisan, without going beyond the scope of the invention. In particular, the concrete configurations of toothing 4, 14 for such a rotary joint may also be effected in a form different from that described here, if this is necessary for reasons of space or design. Further, the use of the indefinite article “a” or “an” does not preclude that the features in question may also be present in multiple form.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A toothing for a rotary joint, which is introduced into a solid material by machining, wherein an interdental space is made between two adjacent teeth, each space having an arcuate termination such that a defined tooth height is ensured and a circumferential residual material ring is disposed above the arcuate termination.

2. The toothing according to claim 1, wherein the individual teeth along the defined tooth height have a tooth geometry for involute toothing.

3. The toothing according to claim 1, wherein the interdental space between the individual teeth has a defined width.

4. The toothing according to claim 1, wherein the arcuate termination of the interdental space is ogival or round-arched.

5. The toothing according to claim 4, wherein the arcuate termination of the interdental space is ogival.

6. A rotary joint of a wind turbine comprising:
a toothing; and
a bearing with an inner ring and an outer ring, which are fabricated from a solid material, the inner ring or the outer ring being operatively connected to an adjusting drive via the toothing,
wherein the toothing has a plurality of teeth introduced into the solid material,
wherein above the teeth a circumferential, completely retained residual material ring remains at a transition to the solid material of the inner ring or the outer ring, which residual material ring stabilizes both the toothing and the inner ring or the outer ring.

7. The rotary joint according to claim 1, wherein the teeth of the toothing have a defined tooth height that are introduced starting from a lower end face of the inner ring or a lower end face of the outer ring, and wherein the toothing between the teeth has a plurality of interdental spaces, each with an arcuate termination, wherein an arcuate termination of the interdental spaces points in a direction of an upper end face of the inner ring or an upper end face of the outer ring, and wherein the circumferential residual material ring remains between the upper end face and the arcuate spaces on the inner ring or on the outer ring.
